(19) United States
(12) Patent Application Publication
(10) Pub. No.: US 2025/0115833 A1
(43) Pub. Date: Apr. 10, 2025

(54) Adhesive Stain-Removing Patch Device

(71) Applicant: Emily Holbrook, Anderson, TX (US)

(72) Inventor: Emily Holbrook, Anderson, TX (US)

(21) Appl. No.: 18/594,098

(22) Filed: Mar. 4, 2024

Related U.S. Application Data
(60) Provisional application No. 63/589,036, filed on Oct. 10, 2023.

(51) Int. Cl. C11D 17/04; C11D 3/384; C11D 17/00

(52) U.S. Cl. CPC C11D 17/046; C11D 3/384; C11D 17/003

(57) ABSTRACT

The present invention relates to an adhesive stain-removing patch device for pre-treating and passive removal of clothing stains. The device can be removed from a backing and secured over a stained area on a piece of clothing via the adhesive. Then, the clothing can be washed wherein the body dissolves during the wash cycle and the compound, which may be a detergent or a stain-removing compound, activates on the stained area to remove the stain.

### CROSS-REFERENCE TO RELATED APPLICATION

The present application claims priority to, and the benefit of, U.S. Provisional Application No. 63/589,036, which was filed on Oct. 10, 2023, and is incorporated herein by reference in its entirety.

### FIELD OF THE INVENTION

The present invention relates generally to the field of stain-removing devices. More specifically, the present invention relates to an adhesive stain-removing patch device for pre-treating and passive removal of clothing stains. The device can be removed from a backing and secured over a stained area on a piece of clothing via the adhesive. Then, the clothing can be washed wherein the body dissolves during the wash cycle and the compound, which may be a detergent or a stain-removing compound, activates on the stained area to remove the stain. Accordingly, the present disclosure makes specific reference thereto. Nonetheless, it is to be appreciated that aspects of the present invention are also equally applicable to other like applications, devices, and methods of manufacture.

### BACKGROUND

Pre-treating a stain on clothing often requires spraying water and/or a liquid stain-removing compound on the clothing and then scrubbing the stained area. However, this cannot be done when clothing becomes stained in public.

Therefore, there exists a long-felt need in the art for an improved stain-removing device. There also exists a long-felt need in the art for an adhesive stain-removing patch device that can be used to pre-treat a stain while in public. In addition, there exists a long-felt need in the art for an adhesive stain-removing patch device that can remove a stain passively while the clothing is being washed.

The subject matter disclosed and claimed herein, in one embodiment thereof, comprises an adhesive stain-removing patch device. The device is primarily comprised of a body impregnated with at least one compound, wherein the body attaches to a backing sheet. The device is intended to be used as a peel-and-stick device that spot removes stains from clothing during a wash cycle. To use the device, the device can be removed from a backing and secured over a stained area on a piece of clothing via the adhesive. Then, the clothing can be washed wherein the body dissolves during the wash cycle and the compound, which may be a detergent or a stain-removing compound, activates on the stained area to remove the stain.

In this manner, the adhesive stain-removing patch device of the present invention accomplishes all the foregoing objectives and provides an improved stain-removing device. To do so, the device can be used to pre-treat a stain while in public. In addition, the device can be used to remove a stain passively while the clothing is being washed.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an adhesive stain-removing patch device. The device is primarily comprised of a body impregnated with at least one compound, wherein the body attaches to a backing sheet. The device is intended to be used as a peel-and-stick device that spot-removes stains from clothing during a wash cycle. In order to accommodate a wide variety, shape, and size of stains on clothing the body may be any shape known in the art. The body is preferably made from a transparent gelatin material. This allows a user to easily place the body over a stain on a piece of clothing because the stain is not obscured by the body.

The gelatin material of the body is preferably water-soluble such that the body dissolves when washed with water (in a washing machine). In addition, the body material is preferably impregnated with at least one compound which may be any stain-removing compound or any detergent compound known in the art. In this manner, the device allows a user to concentrate the compound on only the area of the clothing with the stain, without requiring the user to manually apply the compound.

The body of the device is comprised of a bottom surface comprised of at least one adhesive. The adhesive is preferably any adhesive type known in the art that allows the bottom surface to adhere to a clothing material during a wash cycle. The adhesive is also preferably water-soluble such that it dissolves during a wash cycle.

The present invention is also comprised of a method of use. First, a device is provided comprised of a water-soluble, transparent, gelatinous body impregnated with at least one compound, an adhesive on a bottom surface of the body, and a backing sheet. Then, the body can be peeled from the backing sheet. Then, the body can adhere to clothing over a stain on the clothing such that the body completely covers the stain. Then, the clothing can be washed in a washing machine, wherein the body dissolves such that a detergent and/or stain-removing compound impregnated within the body dissolves into the clothing at the stained area to remove the stain.

Accordingly, the adhesive stain-removing patch device of the present invention is particularly advantageous as it provides an improved stain-removing device. To do so, the device can be used to pre-treat a stain while in public. In addition, the device can be used to remove a stain passively while the clothing is being washed. In this manner, the adhesive stain-removing patch device overcomes the limitations of existing methods of pre-treating and treating stains with existing devices known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a top view of one potential embodiment of an adhesive stain-removing patch device of the present invention in accordance with the disclosed architecture;

FIG. 2 illustrates a top view of one potential embodiment of an adhesive stain-removing patch device of the present invention while attaching to a piece of clothing in accordance with the disclosed architecture;

FIG. 3 illustrates a perspective view of one potential embodiment of an adhesive stain-removing patch device of the present invention in a storage box in accordance with the disclosed architecture; and

FIG. 4 illustrates a flowchart of a method of using one potential embodiment of an adhesive stain-removing patch device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved stain-removing device. There also exists a long-felt need in the art for an adhesive stain-removing patch device that can be used to pre-treat a stain while in public. In addition, there exists a long-felt need in the art for an adhesive stain-removing patch device that can remove a stain passively while the clothing is being washed.

The present invention, in one exemplary embodiment, is comprised of an adhesive stain-removing patch device primarily comprised of a body impregnated with at least one compound, wherein the body attaches to a backing sheet. The device is intended to be used as a peel-and-stick device that spot removes stains from clothing during a wash cycle. The body may be any shape known in the art to accommodate any stain size. The body is preferably made from a transparent gelatin material. This allows a user to easily place the body over a stain on a piece of clothing because the stain is not obscured by the body.

The gelatin material of the body is preferably water-soluble. This allows the body to dissolve when washed with water (in a washing machine). In addition, the body material is preferably impregnated with at least one compound. The compound may be any stain-removing compound or any detergent compound known in the art. In this manner, the device allows a user to concentrate the compound on only the area of the clothing with the stain, without requiring the user to manually apply the compound.

The body of the device is comprised of a bottom surface. The bottom surface is comprised of at least one adhesive. The adhesive is preferably any adhesive type known in the art that allows the bottom surface to adhere to a clothing material during a wash cycle. The adhesive is also preferably water-soluble such that it dissolves during a wash cycle.

The present invention is also comprised of a method of use. First, a device is provided comprised of a water-soluble, transparent, gelatinous body impregnated with at least one compound, an adhesive on a bottom surface of the body, and a backing sheet. Then, the body can be peeled from the backing sheet. Then, the body can adhere to clothing over a stain on the clothing such that the body completely covers the stain. Then, the clothing can be washed in a washing machine, wherein the body dissolves such that a detergent and/or stain-removing compound impregnated within the body dissolves into the clothing at the stained area to remove the stain.

Accordingly, the adhesive stain-removing patch device of the present invention is particularly advantageous as it provides an improved stain-removing device. To do so, the device can be used to pre-treat a stain while in public. In addition, the device can be used to remove a stain passively while the clothing is being washed. In this manner, the adhesive stain-removing patch device overcomes the limitations of existing methods of pre-treating and treating stains with existing devices known in the art.

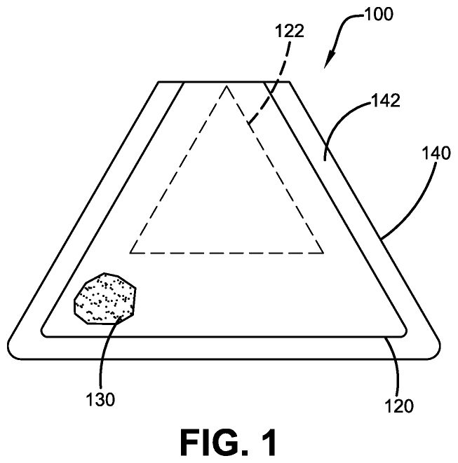

Referring initially to the drawings, FIG. 1 illustrates a top view of one potential embodiment of an adhesive stain-removing patch device 100 of the present invention in accordance with the disclosed architecture. The device 100 is primarily comprised of a body 110 impregnated with at least one compound 130, wherein the body 110 attaches to a backing sheet 140. The device 100 is intended to be used as a peel-and-stick device that spot removes stains from clothing 10 during a wash cycle. In order to accommodate a wide variety, shape, and size of stains on clothing 10 the body 110 may be any shape known in the art such as, but not limited to, square, rectangular, circular, triangular, etc. The body 110 may also be shaped like any object, item, symbol, etc. known in the art for decorative purposes.

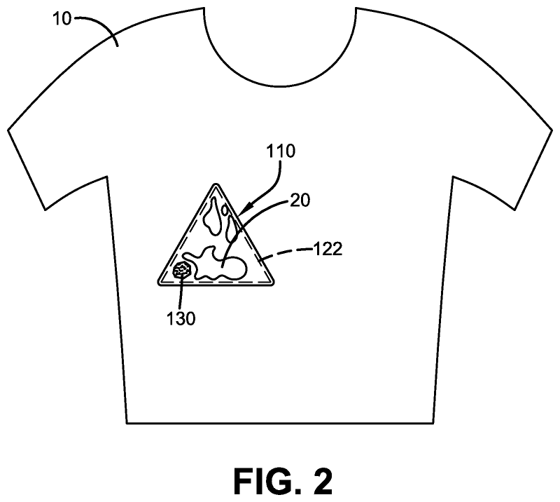

The body 110 is preferably made from a gelatin material. The gelatin material of the body 110 is preferably transparent. This allows a user to easily place the body 110 over a stain 20 on a piece of clothing 10 because the stain 20 is not obscured by the body 110, as seen in FIG. 2.

The gelatin material of the body 110 is preferably water-soluble such that the body 110 dissolves when washed with water (in a washing machine). In addition, the body 110 material is preferably impregnated with at least one compound 130. The compound 130 may be any stain-removing compound known in the art. The compound 130 may also be any detergent compound known in the art. In this manner, the device 100 allows a user to concentrate the compound 130 on only the area of the clothing 10 with the stain 20, without requiring the user to manually apply the compound 130.

The body 110 of the device 100 is comprised of a bottom surface 120 comprised of at least one adhesive 122. The adhesive 122 is preferably any adhesive type known in the art that allows the bottom surface 120 to adhere to a clothing material 10 during a wash cycle. The adhesive 122 is also preferably water soluble such that it dissolves during a wash cycle.

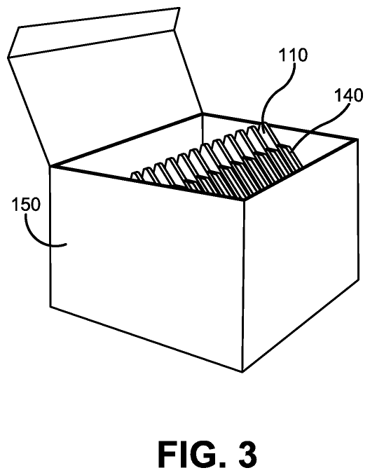

When not in use, the body 110 can be stored on a backing sheet 140. The backing sheet 140 is preferably made from a wax-paper material. The bottom surface 120 of the body 110 further adheres to the top surface 142 of the backing sheet 140 via the adhesive 122. In this manner, the body 110 can be peeled from the backing 140 when it is to be used. The backing 140 (with attached body 110) can be stored in at least one storage box 150 when not in use, as seen in FIG. 3.

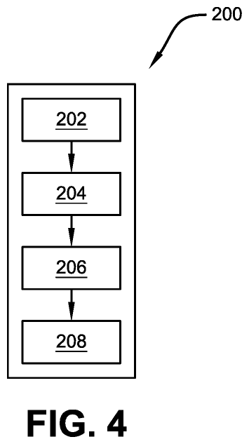

FIG. 4 illustrates a flowchart of a method of using 200 one potential embodiment of an adhesive stain-removing patch device 100 of the present invention in accordance with the disclosed architecture. The present invention is also comprised of a method of use 200. First, a device 100 is provided, the device 100 comprising a water-soluble, transparent, gelatinous body impregnated with at least one compound 130, an adhesive 122 on a bottom surface 120 of the body 110, and a backing sheet 140 [Step 202]. Next, the body 110 can be peeled from the backing sheet 140 [Step 204]. Then, the body 110 can adhere to a clothing 10 over a stain 20 on the clothing 10 such that the body 110 completely covers the stain 20 [Step 206]. Then, the clothing 10 can be washed in a washing machine, wherein the body 110 dissolves such that a detergent and/or stain-removing compound 130 impregnated within the body 110 dissolves into the clothing 10 at the stain 20 area to remove the stain 20 [Step 208].

As a result, the device 100 can be used to pre-treat a stain in public by using the body 110 to cover the stain 20. Then, the body 110 can passively treat the stain 20 when the clothing 10 is washed. It should also be noted that multiple bodies 110 can be used to cover a large stain area 20.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “adhesive stain-removing patch device” and “device” are interchangeable and refer to the adhesive stain-removing patch device 100 of the present invention.

Notwithstanding the foregoing, the adhesive stain-removing patch device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the adhesive stain-removing patch device 100 as shown in the FIGS. are for illustrative purposes only, and that many other sizes and shapes of the adhesive stain-removing patch device 100 are well within the scope of the present disclosure. Although the dimensions of the adhesive stain-removing patch device 100 are important design parameters for user convenience, the adhesive stain-removing patch device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An adhesive stain-removing patch device comprising:
a body impregnated with a compound;
an adhesive; and
a backing sheet.

2. The adhesive stain-removing patch device of claim 1, wherein the backing sheet is comprised of a wax paper.

3. The adhesive stain-removing patch device of claim 1, wherein the compound is comprised of a detergent.

4. The adhesive stain-removing patch device of claim 1, wherein the compound is comprised of a stain-removing compound.

5. The adhesive stain-removing patch device of claim 1, wherein the body is comprised of a gelatinous material.

6. The adhesive stain-removing patch device of claim 5, wherein the gelatinous material is comprised of a transparent gelatinous material.

7. The adhesive stain-removing patch device of claim 5, wherein the gelatinous material is comprised of a water-soluble gelatin.

8. The adhesive stain-removing patch device of claim 1, wherein the adhesive is comprised of a water-soluble adhesive.

9. The adhesive stain-removing patch device of claim 1, wherein the body is comprised of a triangular a shape.

10. An adhesive stain-removing patch device comprising:
a body impregnated with a compound;
an adhesive position on a body surface of the body;
a backing sheet; and
a storage box.

11. The adhesive stain-removing patch device of claim 10, wherein the backing sheet is comprised of a wax paper.

12. The adhesive stain-removing patch device of claim 10, wherein the compound is comprised of a detergent.

13. The adhesive stain-removing patch device of claim 10, wherein the compound is comprised of a stain-removing compound.

14. The adhesive stain-removing patch device of claim 10, wherein the body is comprised of a gelatinous material.

15. The adhesive stain-removing patch device of claim 14, wherein the gelatinous material is comprised of a transparent gelatinous material.

16. The adhesive stain-removing patch device of claim 14, wherein the gelatinous material is comprised of a water-soluble gelatin.

17. The adhesive stain-removing patch device of claim 10, wherein the adhesive is comprised of a water-soluble adhesive.

18. The adhesive stain-removing patch device of claim 10, wherein the body resembles an object, an item, or a symbol.

19. A method of using an adhesive stain-removing patch device, the method comprising the steps of:
providing an adhesive stain-removing patch device, the adhesive stain-removing patch device comprised of a water-soluble, transparent, gelatinous body impregnated with a compound, an adhesive on a bottom surface of the body, and a backing sheet;
removing the body from the backing sheet;
attaching the body to a clothing over a stain on the clothing; and
washing the clothing in a washing machine.

20. The method of claim 19, wherein the compound is comprised of a detergent compound or a stain-removing compound.
